(19) United States
(12) Patent Application Publication
(10) Pub. No.: US 2023/0291120 A1
(43) Pub. Date: Sep. 14, 2023

(54) ANTENNA-DIRECTIVITY ADJUSTMENT SYSTEM, ANTENNA-DIRECTIVITY ADJUSTMENT DEVICE, AND ANTENNA-DIRECTIVITY ADJUSTMENT METHOD

(71) Applicant: NEC Corporation, Tokyo (JP)

(72) Inventor: Takahiro Okano, Tokyo (JP)

(73) Assignee: NEC Corporation, Tokyo (JP)

(21) Appl. No.: 18/106,130

(22) Filed: Feb. 6, 2023

(30) Foreign Application Priority Data
Mar. 8, 2022 (JP) 2022-035702

(51) Int. Cl. H01Q 21/24; H01Q 25/00

(52) U.S. Cl. CPC H01Q 21/24; H01Q 25/001

(57) ABSTRACT

Antenna-directivity adjustment is implemented by adjusting an antenna of a radio communication device in horizontal, vertical, and rotation angles in response to received-signal levels and cross-polarization discriminations. Received-signal levels (RSL) are measured by moving the antenna of the radio communication device in horizontal and vertical directions. Cross-polarization discriminations (XPD) are calculated according to received-signal levels (RSL) measured by changing vertical polarization and horizontal polarization on a transmit side and a receive side with the antenna when rotated and an interference level measured between vertical polarization and horizontal polarization. An antenna direction is adjusted to maximize received-signal levels and cross-polarization discriminations.

### CROSS-REFERENCE TO RELATED APPLICATION

The present application claims the priority benefit of Japanese Patent Application No. 2022-35702 filed on Mar. 8, 2022, the subject matter of which is incorporated herein by reference.

### BACKGROUND OF THE INVENTION

### 1. Field of the Invention

The present disclosure relates to an antenna-directivity adjustment system, an antenna-directivity adjustment device, and an antenna-directivity adjustment method.

### 2. Description of Related Art

As radio communication networks, the point-to-point (P2P) communication technology for performing radio communication among a plurality of communication sites (e.g., base station devices) has been developed such that antenna should be appropriately adjusted in directivity to maximize reception levels between opposing devices which are alienated from each other and directed oppositely to each other in radio communication. Recent telecommunications need a large capacity of communication so as to accelerate usage of high-frequency bands. In general, it is necessary to improve the accuracy of adjusting antennas in directivity as available frequency becomes higher, and therefore it is required to adjust antennas of opposing devices via a precisely-opposite arrangement between antennas. Inter-polarization interference may occur in cross-polarization multiplexing transmission using a plurality of polarizations. To minimize inter-polarization interference, it is necessary to achieve radio reception without causing rotation of polarization for each antenna plane in addition to the accuracy of adjusting antennas in directivity, which may cause difficulty in adjusting antennas in the optimum directivity.

In cross-polarization multiplexing transmission using a plurality of polarizations, it is necessary to set antennas in parallel for the purpose of minimizing inter-polarization interference, and therefore antenna-directivity adjustment may need highly-experienced techniques. For this reason, it is difficult for technicians to adjust antennas in the optimum directivity.

Various techniques have been developed to adjust directivity of antennas. Patent Document 1 discloses an antenna-directivity adjustment device configured to measure an incline of a polarization plane for each antenna via fine adjustment of a polarization angle to change an azimuth in a panning direction with reference to a direction of a receiving antenna (e.g., an azimuth, an elevation, and a polarization angle) which may maximize received power by changing an azimuth in a panning direction for each antenna and an elevation in a tilting direction, thus determining a polarization angle minimizing an amount of bit-error degradation while determining an elevation minimizing an amount of bit-error degradation by changing an azimuth in a panning direction via fine adjustment of an elevation in a tilting direction. Patent Document 2 discloses a communication device configured to adjust antennas in directivity, which is designed to calculate the propagation-path information using radio waves received by each antenna and to thereby display the propagation-path information with an outdoor device, thus allowing a technician to adjust antennas in directivity while confirming the received power and the propagation-path information. Patent Document 3 discloses an antenna adjustment method providing an easy way of adjusting an antenna angle by displaying an antenna-adjustment image showing the reception quality information associated with an antenna angle in a horizontal direction and a vertical direction. Patent Document 4 discloses an antenna-directivity adjustment instrument configured to acquire an antenna angle representing at least one of an elevation and an azimuth for each antenna and to generate and display the first information and the second information based on a reception level [dBm], wherein the first information is a coefficient proportional to a reception level [V/dBm] while the second information is a reception-level voltage [V] produced by multiplying the first information by the reception level. Patent Document 4 further discloses a method for monitoring a reception level while changing a direction of an antenna and for adjusting the antenna in a direction yielding the highest reception level.

Patent Document 1 through Patent Document 4 are each designed to solely use a reception level for each antenna as a parameter used to adjust an antenna direction. A radio communication not necessarily using a plurality of polarizations may not cause inter-polarization interference but realize a sufficient communication quality by simply adjusting an antenna direction using a sole indicator as a reception level for each antenna, and therefore it is unnecessary for a technician to strictly adjust a rotation angle for each antenna. In contrast, a radio communication causing inter-polarization interference suffers from a problem such as degradation of communication quality since a small deviation of a rotation angle for each antenna may degrade a cross-polarization discrimination (XPD). The cross-polarization discrimination is an ability of discriminating a vertical polarization and a horizontal polarization in a linear polarization or a right-handed circular polarization and a left-handed circular polarization in a circular polarization, which can be represented by a power ratio in units of decibels.

### 3. Patent Documents

Patent Document 1: Japanese Patent Application Publication No. 2015-220735
Patent Document 2: Japanese Patent Application Publication No. 2020-205516
Patent Document 3: International Publication WO 2016/136119A1
Patent Document 4: International Publication WO 2018/168274A1

### SUMMARY OF THE INVENTION

An example object of the present disclosure is to provide an antenna-directivity adjustment system, an antenna-directivity adjustment device, and an antenna-directivity adjustment method, which can solve the aforementioned problem.

In a first aspect of the present disclosure, an antenna-directivity adjustment system includes a radio communication device equipped with an antenna, an antenna-directivity adjustment device, and a notification device. The antenna-directivity adjustment device further includes a measurement information acquisition module configured to acquire angle information relating to a horizontal angle, a vertical angle, and a rotation angle of the antenna as well as received-signal levels of the antenna for receiving vertical polarization and horizontal polarization and an interference level between vertical polarization and horizontal polarization with the antenna, a first information generator configured to generate first information representing the received-signal level for each angle, a second information generator configured to generate second information representing the interference level for each angle, and a third information generator configured to calculate a cross-polarization discrimination based on the first information and the second information so as to generate third information representing the cross-polarization discrimination for each angle. The notification device is configured to generate notification information visually expressing the first information, the second information, and the third information.

In a second aspect of the present disclosure, an antenna-directivity adjustment device is configured to adjust an antenna of a radio communication device in directivity. The antenna-directivity adjustment device includes a measurement information acquisition module configured to acquire angle information relating to a horizontal angle, a vertical angle, and a rotation angle of the antenna as well as received-signal levels of the antenna for receiving vertical polarization and horizontal polarization and an interference level between vertical polarization and horizontal polarization with the antenna, a first information generator configured to generate first information representing the received-signal level for each angle, a second information generator configured to generate second information representing the interference level for each angle, and a third information generator configured to calculate a cross-polarization discrimination based on the first information and the second information so as to generate third information representing the cross-polarization discrimination for each angle.

In a third aspect of the present disclosure, an antenna-directivity adjustment method is configured to adjust an antenna of a radio communication device in directivity. The antenna-directivity adjustment method is implemented by setting a horizontal angle and a vertical angle of the antenna responsive to a level of receiving signals with the antenna, measuring a received-signal level of vertical polarization and a received-signal level of horizontal polarization when rotating the antenna, measuring an interference level between vertical polarization and horizontal polarization when rotating the antenna, calculating a cross-polarization discrimination according to the received-signal level for each angle of the antenna and the interference level, and setting a rotation angle of the antenna such that the received-signal level of the antenna is above a predetermined threshold value while the cross-polarization discrimination is above a predetermined value.

In a fourth aspect of the present disclosure, a non-transitory computer-readable storage medium is configured to store a program causing a computer of an antenna-directivity adjustment device configured to adjust an antenna of a radio communication device in directivity to implement: setting a horizontal angle and a vertical angle of the antenna responsive to a level of receiving signals with the antenna; measuring a received-signal level of vertical polarization and a received-signal level of horizontal polarization when rotating the antenna; measuring an interference level between vertical polarization and horizontal polarization when rotating the antenna; calculating a cross-polarization discrimination according to the received-signal level for each angle of the antenna and the interference level; and setting a rotation angle of the antenna such that the received-signal level of the antenna is above a predetermined threshold value while the cross-polarization discrimination is above a predetermined value.

The present disclosure is designed to notify a technician (or a user) of an antenna-directivity adjustment status showing an association between the angle information (relating to horizontal, vertical, and rotation directions of an antenna), received-signal levels, cross-polarization discriminations, and an interference level, thus demonstrating an outstanding effect for the technician to simply and appropriately adjust an antenna direction without relying on his/her skill levels.

### BRIEF DESCRIPTION OF THE DRAWINGS

FIG. 1 is a block diagram showing an antenna-directivity adjustment system according to the first exemplary embodiment of the present disclosure.

FIG. 2 is a block diagram showing an antenna-directivity adjustment device according to the first exemplary embodiment of the present disclosure.

FIG. 3 is a block diagram showing a notification device according to the first exemplary embodiment of the present disclosure.

FIG. 4 is a graph showing an example of a color map produced by mapping the magnitude of a received-signal level (RSL) in a vertical direction and a horizontal direction.

FIG. 5 is a graph for depicting the magnitude of a cross-polarization discrimination (XPD) for each angle relating to an interference level between horizontal polarization and vertical polarization.

FIG. 6 is a flowchart showing an antenna-directivity adjustment method according to the first exemplary embodiment of the present disclosure.

FIG. 7 is a block diagram of an antenna-directivity adjustment system according to the second exemplary embodiment of the present disclosure.

FIG. 8 is a block diagram of an antenna-directivity adjustment device according to the second exemplary embodiment of the present disclosure.

FIG. 9 is a block diagram of a notification device according to the second exemplary embodiment of the present disclosure.

FIG. 10 is a block diagram showing an antenna-directivity adjustment device having a minimum configuration according to one exemplary embodiment of the present disclosure.

FIG. 11 is a flowchart showing a procedure of an antenna-directivity adjustment method according to one exemplary embodiment of the present disclosure.

### DETAILED DESCRIPTION OF THE EXEMPLARY EMBODIMENTS

The present disclosure will be described in detail by way of exemplary embodiments and examples with respect to an antenna-directivity adjustment system, an antenna-directivity adjustment device, and an antenna-directivity adjustment method with reference to the accompanying drawings. The present disclosure is directed to antenna-directivity adjustment for a radio communication device configured to perform radio communication using a plurality of polarizations, wherein antenna-adjustment information is generated to all antenna angles using reception levels of polarizations together with cross-polarization discriminators or interference levels and notified to a technician (e.g., an operator or a user) in an easy-to-understand way, thus achieving appropriate antenna-directivity adjustment. Using angle information acquired from an angle acquisition device attached to each antenna in a horizontal direction and a vertical direction and reception levels acquired from radio communication devices, reception levels for respective angles in horizontal/vertical directions will be notified to a technician. The cross-polarization discrimination information for each rotation angle of antennas is generated based on cross-polarization discriminations or interference levels calculated from the acquired information such as rotation angles of antennas and reception levels of polarizations so as to notify a technician of an optimum direction for each antenna in consideration of inter-polarization interference.

### First Exemplary Embodiment

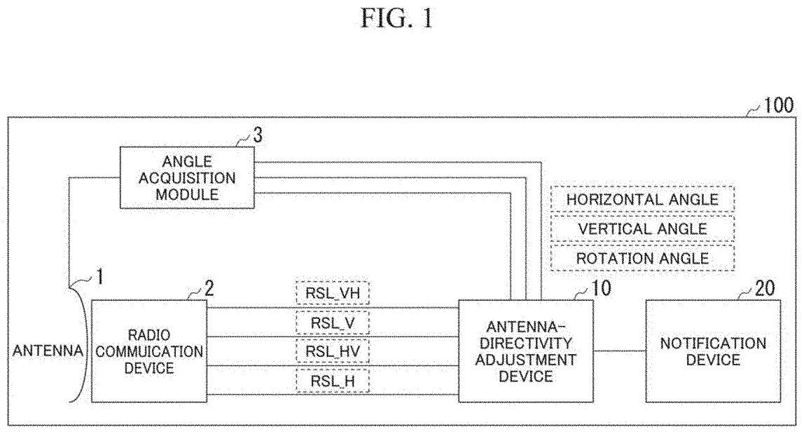

FIG. 1 is a block diagram of an antenna-directivity adjustment system 100 according to the first exemplary embodiment of the present disclosure. The antenna-directivity adjustment system 100 includes an antenna-directivity adjustment device 10 and a notification device 20 with respect to a radio communication device 3 equipped with an antenna 1 and an angle acquisition module 3 for acquiring an angle of the antenna 1. The antenna-directivity adjustment device 10 is arranged externally or internally of the radio communication device 2, while the notification device 20 is arranged externally or internally of the antenna-directivity adjustment device 10. For example, the notification device 20 is a personal computer (PC) or a mobile terminal, which may be equipped with a display and/or a speaker. The notification device 20 is connected to the antenna-directivity adjustment device 10 via a wired communication or a wireless communication. The antenna-directivity adjustment device 10 and the notification device 20 are used for adjusting the direction (or directivity) of the antenna 1. The antenna 1 will be adjusted in an angle to maximize the reception level or the cross-polarization discrimination. In FIG. 1, a symbol “RSL (Received-Signal Level)” represents the received-signal level. Specifically, a symbol “RSL_V” represents the received-signal level of vertical polarization, a symbol “RSL_H” represents the received-signal level of horizontal polarization, a symbol “RSL_V” represents the level of interference from vertical polarization to horizontal polarization, and a symbol “RSL_HV” represents the level of interference from horizontal polarization to vertical polarization.

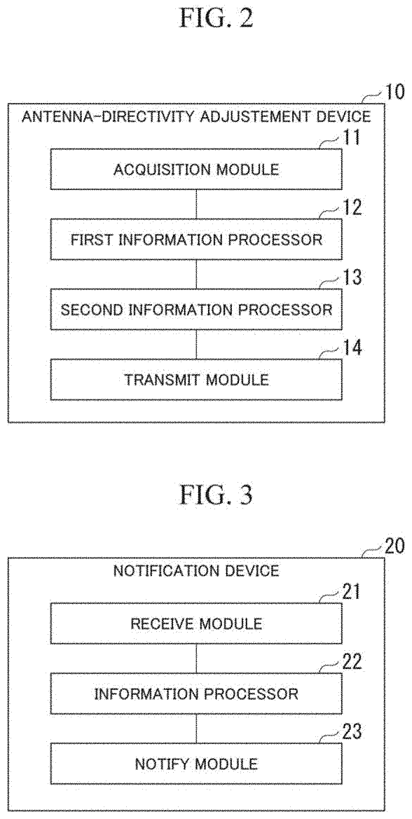

FIG. 2 is a block diagram of the antenna-directivity adjustment device 10 according to the first exemplary embodiment of the present disclosure. The antenna-directivity adjustment device 10 includes an acquisition module 11, a first information processor 12, a second information processor 13, and a transmit module 14. The acquisition module 11 is configured to acquire a horizontal angle, a vertical angle, and a rotation angle of the antenna 1 at the current timing from the angle acquisition module 3 attached to the antenna 1. The acquisition module 11 is configured to acquire angle information from the angle acquisition module 3 attached to the antenna 1, whereas the angle acquisition module 3 can be embedded in the antenna-directivity adjustment device 10. In addition, the acquisition module 11 is configured to acquire the received-signal level of vertical polarization (RSL_V) and the received-signal level of horizontal polarization (RSL_H) transmitted from the radio communication device 2 as well as the interference levels (RSL_VH, RSL_HV) between vertical polarization and horizontal polarization. The acquisition module 11 is configured to transmit to the first information processor 12 the angle information (e.g., a horizontal angle, a vertical angle, and a rotation angle of the antenna 1), the received-signal-level information (RSL_V, RSL_H), and the interference-level information (RSL_VH, RSL_HV).

The first information processor 12 is configured to generate first information representing an association between the angle information and the received-signal-level information which are acquired from the acquisition module 11. The first information, the angle information, and the interference-level information are transmitted to the second information processor 13. The second information processor 13 is configured to generate second information representing an association between the angle information and the interference-level information which are acquired from the first information processor 12. The second information processor 13 is configured to calculate a cross-polarization discrimination “XPD_Cal” for each angle according to the first information and the second information, thus generating third information associated with each angle. Herein, it is possible to express a cross-polarization discrimination relating to vertical polarization “XPD_Cal_V” and a cross-polarization discrimination relating to horizontal polarization “XPD_Cal_H” according to formulae (1), (2).

XPD_Cal_V=RSL_V−RSL_HV (1)

XPD_Cal_H=RSL_H−RSL_VH (2)

In the above, each of symbols “RSL_HV” and “RSL_VH” shows an interference between vertical polarization and horizontal polarization, for example, it may show a reception level on a vertical-polarization side of a receiving device to communicate with a transmitting device for transmitting vertical polarization. It is unnecessary to provide an additional terminal for acquiring an amount of interference. For example, it is possible to confirm “RSL_HV” with a received-voltage terminal on the vertical-polarization side or a monitor for monitoring a reception level.

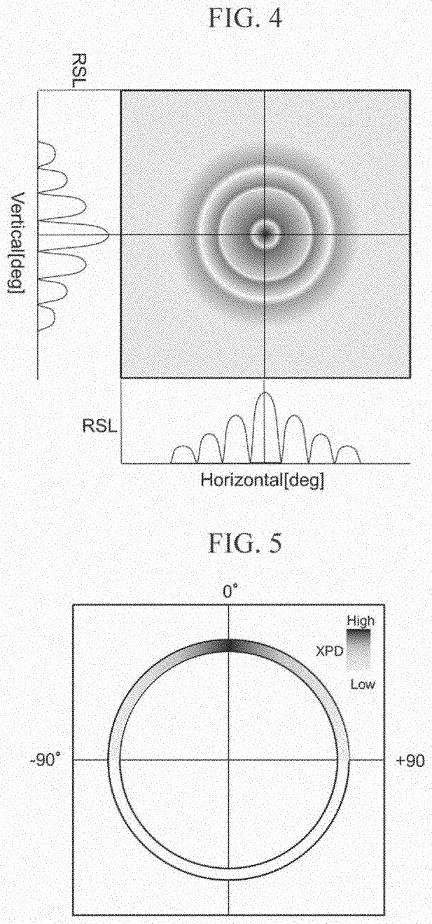

The first information, the second information, and the third information are transmitted to the transmit module 14. The transmit module 14 transmits the first information through the third information to the notification device 20. FIG. 3 is a block diagram of the notification device 20 according to the first exemplary embodiment of the present disclosure. The notification device 20 includes a receive module 21, an information processor 22, and a notify module 23. The receive module 21 is configured to receive from the antenna-directivity adjustment device 10 the received information such as the first information through the third information so as to forward the received information to the information processor 22. The information processor 22 is configured to process the received information in a predetermined form suited to notify the received information to a technician (e.g., an operator or a user). FIG. 4 shows a color map produced by mapping the magnitude of the received-signal level (RSL) according to a horizontal angle and a vertical angle. The information processor 22 may produces a color map representing a gray scale responsive to the magnitude of the received-signal level (RSL) for each angle. FIG. 5 is a graph depicting the magnitude of the cross-polarization discrimination (XPD) for each angle representing an interference level between horizontal polarization and vertical polarization. As described above, the information processor 22 may express the magnitude of the cross-polarization discrimination (XPD) for each angle relating to the interference level in a gray scale. The notify module 23 is configured to notify a technician (e.g., an operator or a user) of the notification information having the predetermined form processed by the information processor 22. Accordingly, it is possible for a technician to adjust an angle of the antenna 1 while checking the magnitude of the received-signal level (RSL) for each angle and the magnitude of the cross-polarization discrimination (XPD) for each angle by visually recognizing the graph of FIG. 4 and the graph of FIG. 5.

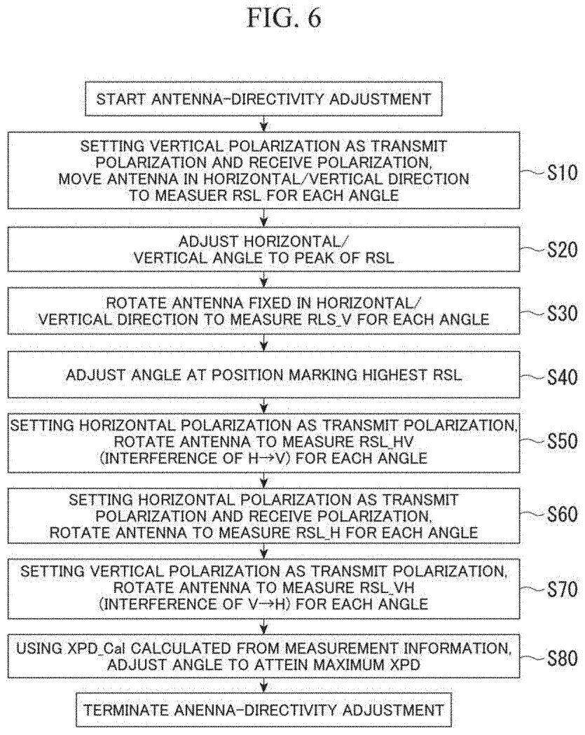

Next, an antenna-directivity adjustment method according to the first exemplary embodiment of the present disclosure will be described in detail with reference to the flowchart of FIG. 6 (steps S10 through S80). At first, a technician (or a user) needs to roughly adjust an antenna angle solely using a single polarization. The flowchart of FIG. 6 starts adjusting an antenna angle with vertical polarization; however, it is possible to arbitrarily determine which of vertical polarization or horizontal polarization will be used for adjusting an antenna angle. First of all, in a state in which a transmit-side polarization (or transmit polarization) and a receive-side polarization (or receive polarization) are both set to vertical polarization, a user moves an antenna in a horizontal direction and/or a vertical direction to measure a received-signal level (RSL) for each angle (S10). Upon confirming the notify information from the notification device 20 interconnected with the antenna-directivity adjustment device 10, the user may adjust an antenna direction to maximize the received-signal level (RSL) (S20). That is, the user may adjust the antenna in a horizontal angle and a vertical angle in conformity with a peak of the received-signal level (RSL). In this case, for example, the user needs to confirm the notify information shown in FIG. 4. The notification device 20 displays the received-signal level (RSL) for each angle so that the user can adjust the antenna direction at the position achieving the highest received-signal level, and therefore the user can fix the antenna in a horizontal angle and a vertical angle.

Next, the user moves the antenna in a rotation direction so as to measure a received-signal level (RSL_V) for each rotation angle (S30), thus adjusting the rotation angle of the antenna at the position achieving the highest received-signal level (S40). Subsequently, the user rotates the antenna again under the condition in which horizontal polarization is solely used for transmit polarization, thus measuring an amount of interference for each rotation angle (i.e., an interference level RSL_HV) (S50). The amount of interference (RSL_HV) indicates an amount of interference of horizontal polarization (H) to vertical polarization (V). Upon confirming the notify information from the notification device 20, the user may temporarily fix the antenna direction at the position minimizing the amount of interference.

Thereafter, transmit polarization and receive polarization are changed to horizontal polarization. Similar to the aforementioned operation, the user may measure the received-signal level (RSL_H) for each rotation angle (S60). Subsequently, by rotating the antenna after changing transmit polarization with vertical polarization, the user may measure an amount of interference for each rotation angle (RSL_VH) (S70). The amount of interference (RSL_VH) indicates an amount of interference of vertical polarization (V) to horizontal polarization (H).

The antenna-directivity adjustment device 10 calculates cross-polarization discriminations (XPD_Cal: XPD_Cal_V, XPD_Cal_H) according to formulae (1), (2) using the aforementioned information of measurements (RSL_V, RSL_H, RSL_HV, RSL_VH), thus displaying the cross-polarization discrimination (XPD_Cal) for each angle with the notification device 20. Upon confirming the cross-polarization discrimination, the user may adjust the antenna angle to maximize the cross-polarization discrimination. In this case, the notification device 20 outputs the notify information representing a graph of FIG. 5 depicting the magnitude of cross-polarization discrimination (XPD) for each angle responsive to the amount of interference.

The first exemplary embodiment uses the rotation angle information in a rotation angle of an antenna in addition to an antenna angle in a horizontal direction and a vertical direction and provides the user (or a technician) with the notify information associated with the amount of interference (RSL_HV, RSL_VH) or the cross-polarization discrimination (XPD) responsive to the measured received-signal level (RSL) for each angle in an easy-to-understand manner. For this reason, the user may instinctively and visually recognize the received-signal level for each vertical/horizontal angle as well as the amount of interference or the cross-polarization discrimination for each rotation angle. In an antenna-directivity adjustment for an antenna using polarization multiplexing transmission in high-frequency bands requiring precise angle adjustment, the user may simply adjust the antenna direction without relying on his/her experience. In a case in which a radio communication device does not possess cross-polarization discriminations (XPD) or in the situation in which a radio communication device cannot output bit-error rates (BER), the first exemplary embodiment can measure an amount of polarization interference solely according to received-signal levels for horizontal/vertical polarizations (RSL_H, RSL_V), thus realizing an adjustment of an antenna angle based on the amount of polarization interference.

### Second Exemplary Embodiment

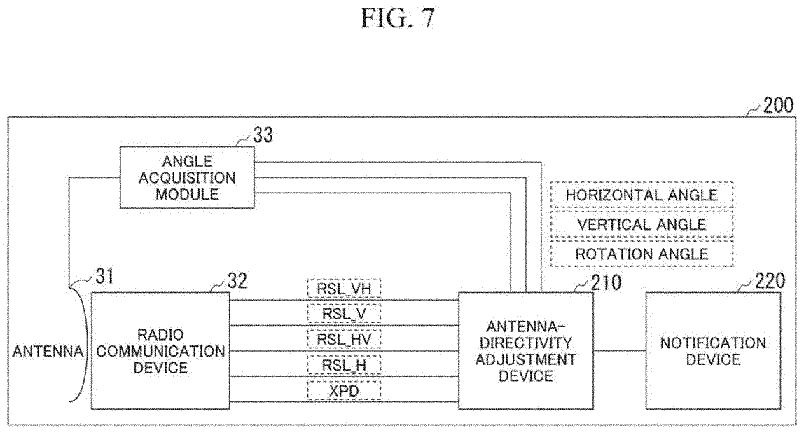

Next, an antenna-directivity adjustment system 200 according to the second exemplary embodiment of the present disclosure will be described with reference to FIG. 7 through FIG. 9. The first exemplary embodiment is designed to calculate cross-polarization discriminations (XPD) according to formulae (1), (2) using measurement information, whereas the second exemplary embodiment is designed to directly acquire cross-polarization discriminations (XPD) from a radio communication device 32. As shown in FIG. 7, the antenna-directivity adjustment system 200 includes an antenna-directivity adjustment device 210 and a notification device 220 with respect to the radio communication device 32 equipped with an antenna 31 and an angle acquisition module 33. The antenna-directivity adjustment device 210 is arranged internally or externally of the radio communication device 32, while the notification device 220 is arranged internally or externally of the antenna-directivity adjustment device 210. The radio communication device 210 is connected to the antenna-directivity adjustment device 210 via a wired communication or a wireless communication. The antenna-directivity adjustment device 210 and the notification device 220 are used for adjusting the antenna 31 in directivity such that an angle of the antenna 31 is adjusted to maximize the received-signal level (RSL) of the antenna 31 while minimizing the amount of interference between horizontal polarization and vertical polarization or maximizing the cross-polarization discrimination. In addition, the radio communication device 32 is configured to measure cross-polarization discriminations (XPD) responsive to interference levels of vertical/horizontal polarizations (RSL_VH, RSL_HV) according to formulae (1), (2).

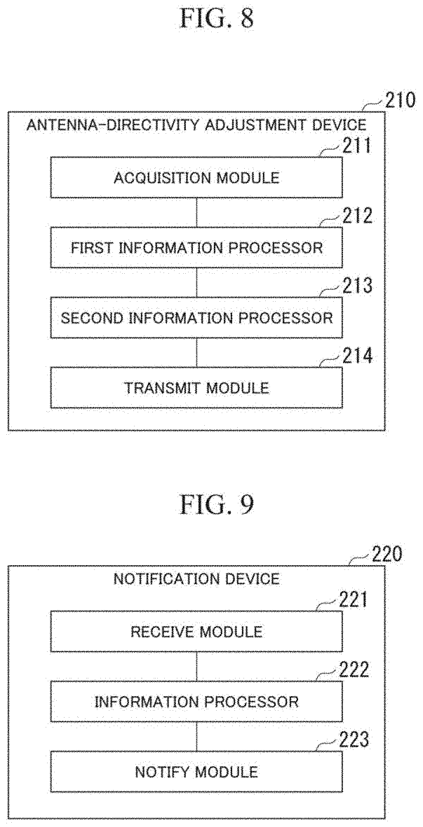

FIG. 8 is a block diagram of the antenna-directivity adjustment device 210 according to the second exemplary embodiment of the present disclosure. The antenna-directivity adjustment device 210 includes an acquisition module 211, a first information processor 212, a second information processor 213, and a transmit module 214. The acquisition module 211 is configured to acquire from the angle acquisition module 33 attached to the antenna 31 a horizontal angle, a vertical angle, and a rotation angle of the antenna 31 at the current timing. The acquisition module 211 is further configured to acquire cross-polarization discriminations (XPD) responsive to a received-signal level of vertical polarization (RSL_V), a received-signal level of horizontal polarization (RSL_H), and interference levels (RSL_VH, RSL_HV) between vertical polarization and horizontal polarization transmitted from the radio communication device 32. The acquisition module 211 transmits the angle information (i.e., a horizontal angle, a vertical angle, and a rotation angle of the antenna 31), the received-signal-level information (RSL_V, RSL_H), and a cross-polarization discrimination (XPD) to the first information processor 212.

The first information processor 212 is configured to generate first information representing an association between the angle information and the received-signal-level information acquired from the acquisition module 211. The angle information and the cross-polarization discrimination are sent to the second information processor 213. The second information processor 213 is configured to generate second information representing an association between the cross-polarization discrimination and the rotation information acquired from the first information processor 212. In addition, the second information processor 213 is configured to generate third information representing an association between the first information and the second information, thus transmitting the third information to the transmit module 214.

The transmit module 214 of the antenna-direction adjustment device 210 is configured to transmit the third information to the notification device 220. FIG. 9 is a block diagram of the notification device 220 according to the second exemplary embodiment of the preset disclosure. The notification device 220 includes a receive module 221, an information processor 222, and a notify nodule 223. The receive module 221 is configured to receive the third information from the antenna-directivity adjustment device 210, thus sending the third information to the information processor 222. The information processor 222 is configured to process the reception information in a predetermined form suited for notifying to a user (or a technician). For example, the information processor 222 may process the third information in the aforementioned expression forms (see FIGS. 4-5), thus notifying to the notify module 223. The notify module 223 is configured to notify the user of the notification information processed in the predetermined form by the information processor 222. This may allow the user to adjust the antenna 21 while confirming the notification information.

### (Minimum Configuration)

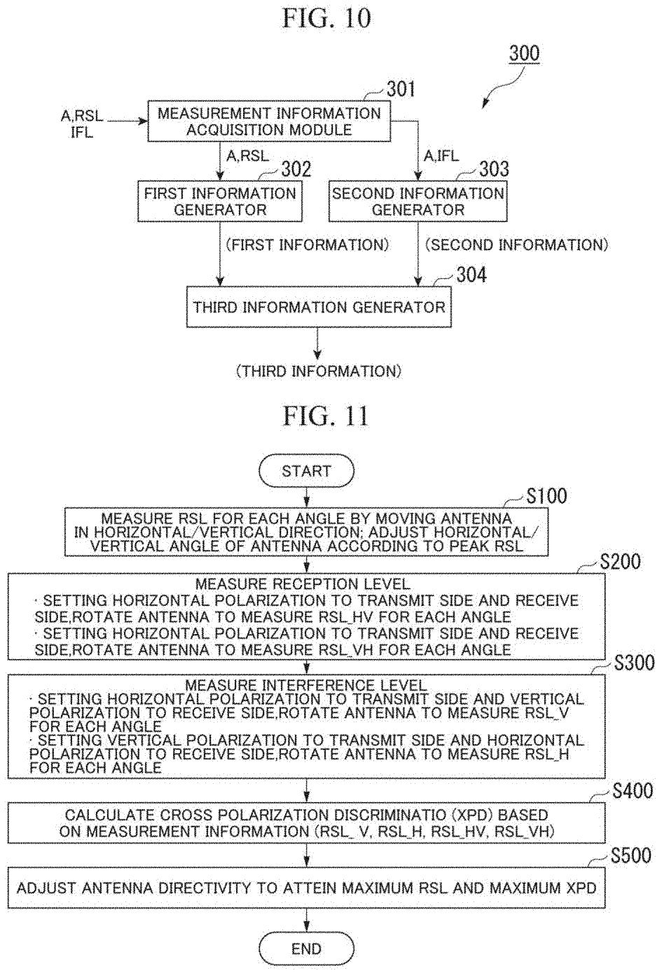

Next, the minimum configuration of an antenna-directivity adjustment device according to one exemplary embodiment of the present disclosure will be described below. FIG. 10 is a block diagram of an antenna-directivity adjustment device 300. The antenna-directivity adjustment device 300 includes a measurement-information acquisition module 301, a first information generator 302, a second information generator 303, and a third information generator 304. The measurement-information acquisition module 301 is configured to acquire angle information (A) from a radio communication device equipped with an antenna angle, such as a horizontal angle (AH), a vertical angle (AV), and a rotation angle (AR) of the antenna. In addition, the measurement-information acquisition module 301 is configured to acquire received-signal-level information (RSL) including received-signal levels of horizontal and vertical polarizations (RSL_H, RSL_V) and interference-level information (IFL) relating to interference levels (RSL_H, RSL_V). The first information generator 302 is configured to generate first information for received-signal levels for each angle representing an association between the angle information (A) and the received-signal-level information (RSL). The second information generator 303 is configured to generate second information for interference levels for each angle representing an association between the angle information (A) and the interference-level information (IFL). The third information generator 304 is configured to calculate a cross-polarization discrimination (XPD) according to formulae (1), (2) using the first information and the second information, thus generating third information representing the cross-polarization discrimination (XPD) for each angle. With reference to the first information, the second information, and the third information, a user may adjust an antenna direction to maximize the received-signal level (RSL) and the cross-polarization discrimination (XPD). Adjustment of an antenna direction is not necessarily limited to an adjustment for maximizing the received-signal level (RSL) and the cross-polarization discrimination (XPD), and therefore it is possible to adjust an antenna direction such that the received-signal level falls within a predetermined range satisfying desired communication quality while the cross-polarization discrimination falls within a predetermined range sufficiently discriminating vertical polarization and horizontal polarization. Alternatively, it is possible to adjust an antenna direction such that the received-signal level is above a predetermined threshold value while the cross-polarization discrimination is above a predetermined value.

### (Antenna-Directivity Adjustment Method)

Next, an antenna-directivity adjustment method according to one exemplary embodiment of the present disclosure will be described below. FIG. 11 is a flowchart showing a procedure of the antenna-directivity adjustment method (steps S100 through S500). At first, a technician (or a user) for setting up an antenna of a radio communication device moves the antenna in a horizontal direction and/or a vertical direction to measure a received-signal level (RSL) for each angle, thus adjusting the antenna in the horizontal/vertical directions in conformity of a peak of the RSL (S100). Subsequently, the user rotates the antenna to measure a received-signal level (RSL) (S200). Specifically, the user sets a transmit side and a receive side to vertical polarization and then rotates the antenna to measure an interference level for each angle (RSV_V) while the user sets a transmit side and a receive side to horizontal polarization and then rotates the antenna to measure an interference level for each angle (RSL_H). Subsequently, the user measures an interference level between horizontal polarization and vertical polarization (S300). Specifically, the user sets the transmit side to horizontal polarization while setting the receive side to vertical polarization, and then the user rotates the antenna to measure an interference level for each angle (RSL_HV). In addition, the user sets the transmit side to vertical polarization while setting the receive side to horizontal polarization, and then the user rotates the antenna to measure an interference level for each angle (RSL_VH).

A cross-polarization discrimination (XPD) will be calculated according to formulae (1), (2) using the measurement information (RSL_V, RSL_H, RSL_HV, RSL_VH) (S400). Subsequently, the user adjusts an antenna direction to maximize the received-signal level (RSL) and the cross-polarization discrimination (XPD) (S500). In this connection, it is possible to modify the procedure of FIG. 11 including steps S100 through S500 by changing the order of implementing received-signal-level measurement (S200) and interference-level measurement (S300).

The antenna-directivity adjustment device 10 of FIG. 2, the antenna-directivity adjustment device 210 of FIG. 8, and the antenna-directivity adjustment device 300 of FIG. 10 have computer systems (including hardware and software), wherein the foregoing processes as shown in FIG. 6 and FIG. 11 are realized by programs and stored on computer-readable storage media; hence, computers may read and execute programs to implement the foregoing processes. As a processor incorporated into a computer, it is possible to use not only a CPU (Central Processing Unit) but also a GPU (Graphics Processing Unit) or the like to execute computational processes. Moreover, it is possible to use various types of programs such as embedded programs and network programs.

The foregoing exemplary embodiments are each designed to use an angle acquisition module in connection with a radio communication device equipped with an antenna. Herein, the angle acquisition module can be connected online with the radio communication device so as to acquire a horizontal angle, a vertical angle, and a rotation angle of the antenna. In addition, the notification device is not necessarily arranged independently of the antenna-directivity adjustment device. For example, it is possible to install in the antenna-directivity adjustment device a display device having a notification function of measurement information.

Lastly, the present disclosure is directed to a technology for adjusting an antenna direction of a radio communication device, wherein the radio communication device is not necessarily set up at a fixed position, and therefore the present disclosure is applicable to a movable-type radio communication device or a mobile-type radio communication device mounted on a drone or the like. Antenna-direction adjustment may not necessarily be manually conducted by a technician, and therefore it is possible to adjust the direction of a drive-type antenna using a servo motor in response to received-signal levels and cross-polarization discriminations. In this connection, the present disclosure is not necessarily limited to the foregoing exemplary embodiments, and therefore the present disclosure may embrace various modifications and design changes for the purpose of adjusting antennas of radio communication devices in horizontal, vertical, and rotation directions responsive to received-signal levels and cross-polarization discriminations.

What is claimed is:

1. An antenna-directivity adjustment system comprising a radio communication device equipped with an antenna, an antenna-directivity adjustment device, and a notification device,
wherein the antenna-directivity adjustment device comprises
a measurement information acquisition module configured to acquire angle information relating to a horizontal angle, a vertical angle, and a rotation angle of the antenna as well as received-signal levels of the antenna for receiving vertical polarization and horizontal polarization and an interference level between the vertical polarization and the horizontal polarization with the antenna,
a first information generator configured to generate first information representing the received-signal level for each angle,
a second information generator configured to generate second information representing the interference level for each angle, and
a third information generator configured to calculate a cross-polarization discrimination based on the first information and the second information so as to generate third information representing the cross-polarization discrimination for each angle, and
wherein the notification device is configured to generate notification information visually expressing the first information, the second information, and the third information.

2. An antenna-directivity adjustment device configured to adjust an antenna of a radio communication device in directivity, comprising:
a measurement information acquisition module configured to acquire angle information relating to a horizontal angle, a vertical angle, and a rotation angle of the antenna as well as received-signal levels of the antenna for receiving vertical polarization and horizontal polarization and an interference level between the vertical polarization and the horizontal polarization with the antenna,
a first information generator configured to generate first information representing the received-signal level for each angle,
a second information generator configured to generate second information representing the interference level for each angle, and
a third information generator configured to calculate a cross-polarization discrimination based on the first information and the second information so as to generate third information representing the cross-polarization discrimination for each angle.

3. The antenna-directivity adjustment device according to claim 2, wherein the first information represents a vertical-polarization reception level responsive to the rotation angle of the antenna when receiving or transmitting the vertical polarization and a horizontal-polarization reception level responsive to the rotation angle of the antenna when receiving or transmitting the horizontal polarization, and wherein the second information represents a first interference level indicating a first interference from the horizontal polarization to the vertical polarization and a second interference level indicating a second interference from the vertical polarization to the horizontal polarization in response to the rotation angle of the antenna.

4. The antenna-directivity adjustment device according to claim 3, wherein the third information represents a first cross-polarization discrimination about a first difference between the vertical-polarization reception level and the first interference level and a second cross-polarization discrimination about a second difference between the horizontal-polarization reception level and the second interference level.

5. An antenna-directivity adjustment method configured to adjust an antenna of a radio communication device in directivity, comprising:
setting a horizontal angle and a vertical angle of the antenna responsive to a level of receiving signals with the antenna;
measuring a received-signal level of vertical polarization and a received-signal level of horizontal polarization when rotating the antenna;
measuring an interference level between the vertical polarization and the horizontal polarization when rotating the antenna;
calculating a cross-polarization discrimination according to the received-signal level for each angle of the antenna and the interference level; and
setting a rotation angle of the antenna such that the received-signal level of the antenna is above a predetermined threshold value while the cross-polarization discrimination is above a predetermined value.
